(19) United States
(12) Patent Application Publication
(10) Pub. No.: US 2025/0028628 A1
(43) Pub. Date: Jan. 23, 2025

(54) AUTOMATED DEBUGGING OF KUBERNETES APPLICATION

(71) Applicant: VMware LLC, Palo Alto, CA (US)

(72) Inventors: Yu Ying, Cupertino, CA (US); Hayden Kevin Fowler, San Jose, CA (US); Sreeram Kumar Ravinoothala, San Jose, CA (US); Di Wang, Santa Clara, CA (US); Yong Wang, San Jose, CA (US)

(21) Appl. No.: 18/225,027

(22) Filed: Jul. 21, 2023

(51) Int. Cl. G06F 11/36; G06F 11/07

(52) U.S. Cl. CPC G06F 11/366; G06F 11/0778; G06F 11/079

(57) ABSTRACT

Some embodiments provide a method for monitoring a first service that executes in a Pod on a node of a Kubernetes deployment. At a second service executing on the node, the method monitors a storage of the node that stores core dump files to detect when a core dump file pertaining to the first service is written to the storage. Upon detection of the core dump file being written to the storage, the method automatically (i) generates an image of the first service based on data in the core dump file and (ii) instantiates a new container on the node to analyze the generated image in order to debug the first service.

### BACKGROUND

Today, Kubernetes is the de-facto orchestration platform that automates the process of deploying and managing micro-service-based cloud-native applications at massive scale. In many deployments, an application may have multiple components that run on various different nodes (and possibly on different hosts). When one component crashes, a user (e.g., an admin) will typically identify the host on which the crash occurred, retrieve the necessary credentials, and log into that host to run certain troubleshooting workflows. The user will then copy data to the on-prem datacenter so that the data can be shared with the app developer in order to identify the root cause of the crash. This can be a tedious process, and thus improvements to facilitate debugging of Kubernetes deployments are useful.

### BRIEF SUMMARY

Some embodiments of the invention provide a method for automated monitoring and debugging of a Kubernetes application component. Specifically, to monitor a first service that executes within a first Pod on a node of a Kubernetes cluster, a second service (a monitoring service) monitors a node storage to detect when a core dump file pertaining to that first service is written to the storage (which is indicative of the first service crashing). Upon detection of the core dump file being written to the storage, the monitoring service automatically generates an image of the first service (based in part on data in the core dump file) and instantiates a new container separate from the Pods (or a second Pod) on the node to analyze the generated image and generate debugging information.

In some embodiments, the first service is a datapath that performs logical forwarding operations for multiple logical routers of a logical network. The logical routers are defined to include certain layer 7 (L7) services, which are performed by separate Pods. That is, the implementation of the logical routers in the Kubernetes cluster involves one or more Pods that perform logical forwarding based on layer 2-layer 4 (L2-L4) parameters for multiple logical routers (“L4 Pods”) as well as separate Pods that each perform one or more L7 services for a single logical router. In some embodiments, the L4 Pod is affinitized to a specific node of the cluster, while the L7 Pods are distributed across multiple nodes (typically including the node on which the L4 Pod executes). The monitoring service, in some embodiments, is specifically configured to monitor the L4 Pod and thus executes on the same node as the L4 Pod.

Within the L4 Pod, several components execute in some embodiments. These components include a datapath (e.g., a data plane development kit (DPDK) datapath) that performs the actual logical forwarding as well as agents for configuring the datapath and the L7 Pods (executing on both the same node as well as the other nodes) based on data received from an external network management system (e.g., a network management system with which users can interact in order to define logical network configuration).

The monitoring service, as mentioned, monitors a node storage to detect when core dump files are written to this storage matching a set of criteria that indicate the core dump files relate to the L4 Pod (and/or specifically the datapath executing in the L4 Pod). In some embodiments, the monitored storage is a persistent volume storage that is shared between the L4 Pod and the monitoring service, as well as the new container once that container is instantiated.

Upon detection of a core dump file pertaining to the L4 Pod, the monitoring service of some embodiments generates an image of the service executing in the L4 Pod (e.g., the datapath). To generate this image, the monitoring service identifies all of the software packages executing for the first service (e.g., various data processing threads and control threads for the datapath, DPDK libraries, etc.). In some embodiments, the software packages are identified at least in part based on the naming string of the core dump file and version information stored at the node. Having determined these software packages, the monitoring service automatically generates a document that includes a set of commands for building an image based on the crashed service (e.g., a DockerFile for a Docker container). The monitoring service then builds the image using this generated document and instantiates the new container (or a second Pod) to house this newly built image.

The new container downloads the identified software packages into the user space of the container image in some embodiments. The new container is also instantiated with a set of automated scripts that analyze the core dump file and the generated image (e.g., to generate GNU Debugger (gdb) analysis results of the core dump file). These analysis results can be packed into support bundles for offline analysis (e.g., root cause analysis). In some embodiments, the new container exits (e.g., is deleted) after the automated scripts are complete. In other embodiments, however, the new container remains up and is accessible by a user (e.g., an administrator, an application developer, etc.). This enables the user to perform real-time debugging of the L4 Pod on the node.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates an overview of a Kubernetes cluster of some embodiments in which a set of Pods implement multiple logical routers for a logical network.

FIG. 2 conceptually illustrates a network management system that provides network configuration information to an L4 Pod as well as to the Kubernetes control plane.

FIG. 3 conceptually illustrates the architecture of a node of some embodiments on which such a monitoring service executes to monitor an L4 Pod.

FIG. 4 conceptually illustrates a process of some embodiments for performing automated debugging of a monitored service.

FIG. 5 which conceptually illustrates a monitoring service instantiating a new container with an image of a crashed datapath for analysis.

FIG. 6 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for automated monitoring and debugging of a Kubernetes application component. Specifically, to monitor a first service that executes within a first Pod on a node of a Kubernetes cluster, a second service (a monitoring service) monitors a node storage to detect when a core dump file pertaining to that first service is written to the storage (which is indicative of the first service or the Pod on which it executes crashing). Upon detection of the core dump file being written to the storage, the monitoring service automatically generates an image of the first service (based in part on data in the core dump file) and instantiates a second Pod (or a container separate from the Pods) on the node to analyze the generated image and generate debugging information.

In some embodiments, the first service is a datapath that performs logical forwarding operations for multiple logical routers of a logical network. The logical routers are defined to include certain layer 7 (L7) services, which are performed by separate Pods. That is, the implementation of the logical routers in the Kubernetes cluster involves one or more Pods that perform logical forwarding based on layer 2-layer 4 (L2-L4) parameters for multiple logical routers (“L4 Pods”) as well as separate Pods that each perform one or more L7 services for a single logical router. In some embodiments, the L4 Pod is affinitized to a specific node of the cluster, while the L7 Pods are distributed across multiple nodes (typically including the node on which the L4 Pod executes). The monitoring service, in some embodiments, is specifically configured to monitor the L4 Pod and thus executes on the same node as the L4 Pod.

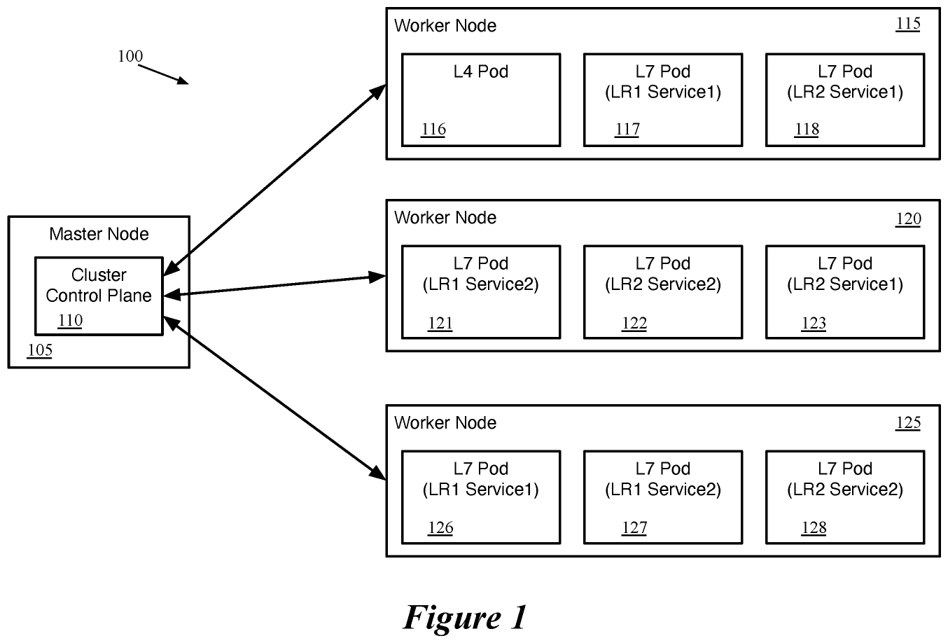

FIG. 1 conceptually illustrates an overview of a Kubernetes cluster 100 of some embodiments in which a set of Pods implement multiple logical routers for a logical network. As shown, the cluster 100 includes a master node 105 that executes a set of cluster control plane components 110 as well as a set of worker nodes 115, 120, and 125, each of which execute a respective set of Pods that collectively implement the set of logical routers. Specifically, the first worker node 115 executes an L4 Pod 116 and two L7 Pods 117 and 118. These L7 Pods 117 implement respective L7 services for two different logical routers. For both of these logical routers, the L4 Pod 116 implements logical forwarding (e.g., routing) operations as well as L4 operations (e.g., network address and/or port translation). The second worker node 120 executes three L7 Pods 121-123. The first of these Pods 121 implements a second L7 service for the first logical router, the second Pod 122 implements a second L7 service for the second logical router, and the third Pod 123 implements the first L7 service for the second logical router (allowing the L4 Pod to load balance between the Pod 118 and the Pod 123) for the provision of this L7 service. Finally, the third worker node also executes three L7 Pods 126-128. In this case, the first Pod 126 implements the first L7 service for the first logical router, the second Pod 127 implements the second L7 service for the first logical router, and the third Pod 128 implements the second L7 service for the second logical router.

Each logical router is configured (e.g., by a network administrator) to perform a respective set of services on data messages handled by that logical router. In this case, each of the two logical routers is configured to perform two different services on data messages processed by the respective logical routers. These services may be the same two services for each of the logical routers or different sets of services. The services, in some embodiments, include L5-L7 services, such as L7 firewall services, transport layer security (TLS) services (e.g., TLS proxy), L7 load balancing services, uniform resource locator (URL) filtering, and domain name service (DNS) forwarding. As in this example, if multiple such services are configured for a given logical router, each of these services is implemented by a separate L7 Pod in some embodiments. In other embodiments, one L7 Pod performs all of the services configured for its logical router. Furthermore, some embodiments execute a single L7 Pod for each service (or for all of the services), while other embodiments (as in this example) execute multiple L7 Pods and load balance traffic between the Pods.

The master node 105, in some embodiments, includes various cluster control plane components 110 that control and manage the worker nodes 105, 110, and 115 of the cluster 100 (as well as any additional worker nodes in the cluster). In different embodiments, a cluster may include one master node or multiple master nodes, depending on the size of the cluster deployment. When multiple master nodes are included for a large cluster, these master nodes provide high-availability solutions for the cluster. The cluster control plane components 110, in some embodiments, include a Kubernetes application programming interface (API) server via which various Kubernetes constructs (Pods, custom resources, etc.) are defined for the cluster, a set of controllers to run the cluster, a state database for the cluster (e.g., etcd), and a scheduler for scheduling Pods across the worker nodes and for scheduling functionalities for worker nodes in the cluster. In different embodiments, the master node 105 may execute on the same host computer as some or all of the worker nodes of the cluster or on a separate host computer from the worker nodes.

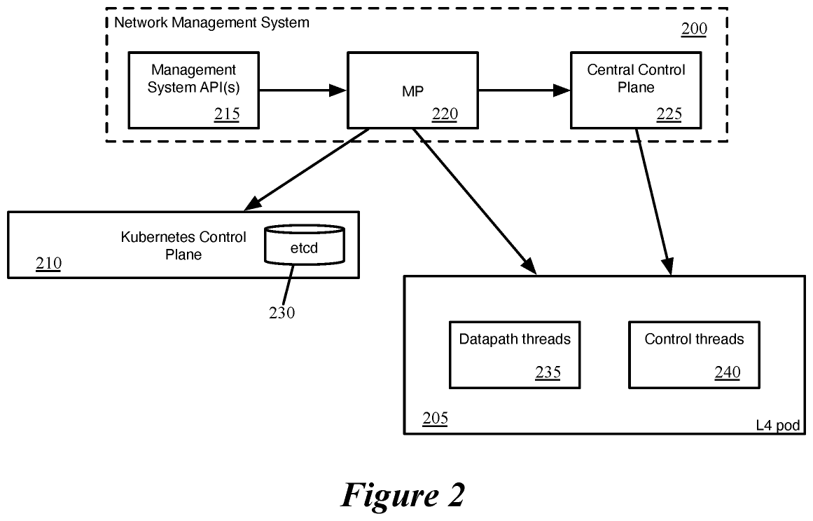

In some embodiments, the logical router (and additional logical network elements and policies implemented in the cluster) are managed by an external network management system. FIG. 2 conceptually illustrates a network management system 200 that provides network configuration information to an L4 Pod 205 as well as to the Kubernetes control plane 210. The network management system 200 includes a set of management system APIs 215, a management plane 220, and a central control plane 225. In some embodiments, the network management system is implemented outside of the Kubernetes cluster or (at least partially) in a separate Kubernetes cluster. For instance, the network management system 200 might reside in an enterprise datacenter and manage both a physical datacenter as well as the Kubernetes cluster in which the logical routers are implemented (which might be hosted in the enterprise datacenter or in a public cloud datacenter).

The management system APIs 215 are the interface through which a network administrator defines a logical network and its policies. This includes the configuration of the logical forwarding rules and the L7 services for the logical routers implemented within the Kubernetes cluster. The administrator (or other user) can specify, for each logical router, which L7 services should be performed by the logical router, on which data messages processed by the logical router each of these L7 services should be performed, and specific configurations for each L7 service (e.g., how L7 load balancing should be performed, URL filtering rules, etc.).

The management plane 220, in some embodiments, communicates with both the Kubernetes cluster control plane 210 and the L4 Pod 205 (or multiple L4 Pods in case there is more than one L4 Pod in the cluster). In some embodiments, the management plane 220 is responsible for managing life cycles for at least some of the Pods (e.g., the L4 Pod) via the Kubernetes control plane 210.

The Kubernetes control plane 210, as described above, includes a cluster state database 230 (e.g., etcd), as well as an API server. The API server (not shown in this figure), in some embodiments, is a frontend for the Kubernetes cluster that allows for the creation of various Kubernetes resources. In some embodiments, in order to add a new Pod to the cluster, either the management plane 220 or another entity (e.g., an agent executing on the L4 Pod 205) interacts with the Kubernetes control plane to create this Pod.

The management plane 220 also provides various logical network configuration data (e.g., forwarding and service policies) to the central control plane 225. The central control plane 225, in some embodiments, provides this information directly to the Pods. In some embodiments, various agents execute on the nodes and/or Pods to receive configuration information from the central control plane 225 and/or the management plane 220 and configure entities (e.g., forwarding elements, services, etc.) on the Pods (or in the nodes for inter-Pod communication) based on this configuration information. For instance, as described below, logical router configuration is provided to the L4 Pod by the central control plane 225.

The L4 Pod 205, as shown, executes both datapath threads 235 and control threads 240. In some embodiments, the L4 Pod 205 executes a data plane development kit (DPDK) datapath that uses a set of run-to-completion threads (the datapath threads 235) for processing data messages sent to the logical router as well as a set of control threads 240 for handling control plane operations. Each datapath thread 235, in some embodiments, is assigned (i.e., pinned) to a different core of a set of cores of a computing device on which the first Pod executes, while the set of control threads 240 are scheduled at runtime between the cores of the computing device. The set of data message processing operations performed by the L4 pod (e.g., by the datapath threads 235) includes L2-L4 operations, such as L2/L3 lookups, tunnel termination/encapsulation, L2-L4 firewall processing, packet updating, and byte counters.

As mentioned, in some embodiments a monitoring service executing on the same node as the L4 Pod is configured to monitor a node storage in order to detect when the datapath of the L4 Pod has crashed (or the L4 Pod itself has crashed), in order to perform automated debugging of the datapath. It should be noted that, while the invention is discussed in reference to the datapath of the L4 Pod, the invention is also applicable to the monitoring of other services executing within a container cluster (e.g., L7 services executing on an L7 Pod, other types of services that might execute in a Kubernetes cluster, etc.).

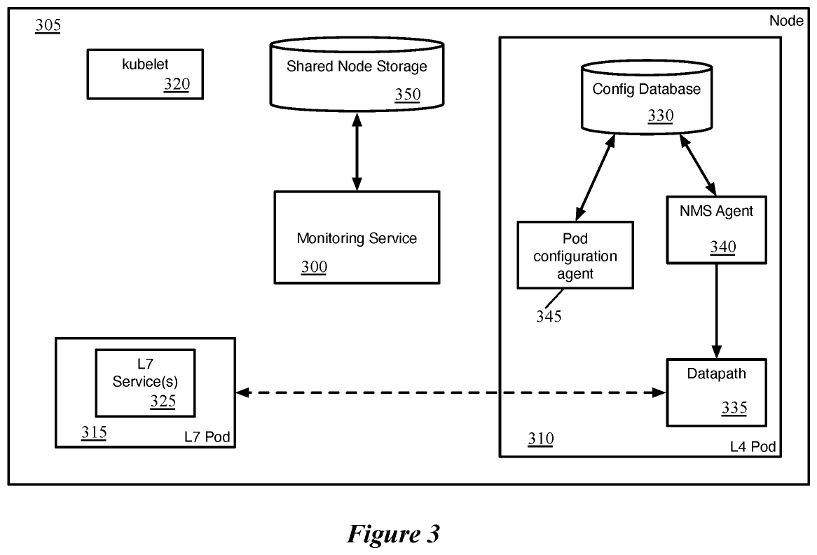

FIG. 3 conceptually illustrates the architecture of a node 305 of some embodiments on which such a monitoring service 300 executes to monitor an L4 Pod 310. In addition to the L4 Pod 310 and the monitoring service 300, an L7 Pod 315 and kubelet 320 also execute on the node 305. The kubelet 320, while separate from the Kubernetes control plane, acts in concert with the control plane. The kubelet is a Kubernetes component that executes on each node of a cluster and acts as an agent for the control plane. The kubelet 320 is responsible for creating and/or deleting Pods on its node 305 and ensuring that these Pods are running and healthy.

The L7 Pod 315 may be one of multiple L7 Pods that operate on the node 305, in addition to other L7 Pods operating on various other nodes. Within the L7 Pod 315, a set of L7 services 325 execute. The L7 services 325 perform L7 service operations on data message traffic (e.g., TLS proxy operations, L7 load balancing, URL filtering, etc.). While the monitoring service 300 described herein monitors the datapath service in the L4 Pod 310, in other embodiments a separate monitoring service is configured to monitor the L7 services to identify if and when these services crash.

The L4 Pod 310 stores a configuration database 330, in addition to executing the datapath 335, a network management system agent 340, and a Pod configuration agent 345. The configuration database (e.g., NestDB) receives and stores configuration data for the logical routers implemented by the L4 Pod 310 from the network management system (e.g., the network control plane). In some embodiments, for each logical router, this configuration data includes at least (i) logical forwarding configuration, (ii) L7 service configuration, and (iii) internal network connectivity between the L4 and L7 pods. The logical forwarding configuration defines routes (as well as L3/L4 services, such as network address translation) to be implemented by the L4 Pod 310, while the L7 service configuration defines the services to be performed by the logical router and the configuration for each of those services. The internal network connectivity, in some embodiments, is defined by the network management system (e.g., is transparent to the network administrator) and specifies how the L4 Pod 300 and the L7 Pod(s) send data traffic back and forth.

The Pod configuration agent 345 is responsible for the creation and at least part of the configuration of the L7 Pods (e.g., the L7 Pod 315) for the various logical routers implemented by the L4 Pod 300. In some embodiments, when the Pod configuration agent 345 detects that a new L7 Pod needs to be created, the Pod configuration agent interacts with the cluster API server to create this Pod. Similarly, the Pod configuration agent 345 detects when an L7 Pod should be deleted and interacts with the cluster API server to remove the L7 Pod. The Pod configuration agent 345 is also responsible for providing network interface configuration data to the L7 Pod 315 in some embodiments, to enable its communication with the datapath 335 of the L4 Pod 310.

The network management system agent 340, in some embodiments, reads logical forwarding configuration data for each of the logical routers that the L4 Pod 300 is responsible for implementing from the configuration database 330 and uses this logical forwarding configuration data to configure the datapath 335 to perform logical forwarding operations on data messages sent to the L4 Pod for processing by any of these logical routers. In some embodiments, the network management system agent 340 configures routing tables (e.g., virtual routing and forwarding (VRF) tables) on the datapath 335 for each of the logical routers.

The datapath 335 implements the data plane for the logical routers. The datapath 335 includes one or more interfaces through which it receives logical network data traffic (e.g., from networking constructs on the node 305) and performs logical forwarding operations. The logical forwarding operations include routing data traffic to other logical routers, to network endpoints, to external destinations, and/or to one or more L7 Pods. In some embodiments, policy-based routing is used to ensure that certain data messages are initially routed to one or more L7 Pods and only routed towards an eventual destination after all necessary L7 services have been performed on the data messages. As described above, the datapath 335 includes both datapath threads for performing data message processing as well as various control threads. In some embodiments, the datapath 335 is the service monitored by the monitoring service 300 executing on the node 305.

The monitoring service 300, in some embodiments, is a stand-alone service executing on the node 305 separate from any Pods. In different embodiments, the monitoring service 300 executes within a container (outside of a Pod) or as a service directly on the node 305. The monitoring service 300, as mentioned, monitors a shared node storage 350 to detect when core dump files are written to this storage 350 that match a set of criteria that indicate the core dump files relate to the L4 Pod (and/or specifically the datapath executing in the L4 Pod). In some embodiments, the monitored storage 350 is a persistent volume storage that is shared between the L4 Pod 310 and the monitoring service 300

Upon detection of a core dump file pertaining to the L4 Pod 310 in the shared node storage 350, the monitoring service 300 generates an image of the datapath 335 that was executing in the L4 Pod 310 (i.e., the service that the monitoring service 300 is configured to monitor). To generate this image, the monitoring service 300 identifies all of the software packages executing for the first datapath 335. For instance, in some embodiments these services include the various data processing threads and control threads for the datapath, DPDK libraries, etc. The monitoring service 300 automatically generates a document that includes a set of commands for building the image (e.g., a DockerFile for a Docker container), then builds the image using this document and instantiates the newly built image. In different embodiments, this new image is instantiated in a new Pod, in a separate container on the node 305 that is not part of a Kubernetes Pod, or simply as a new service on the node 305.

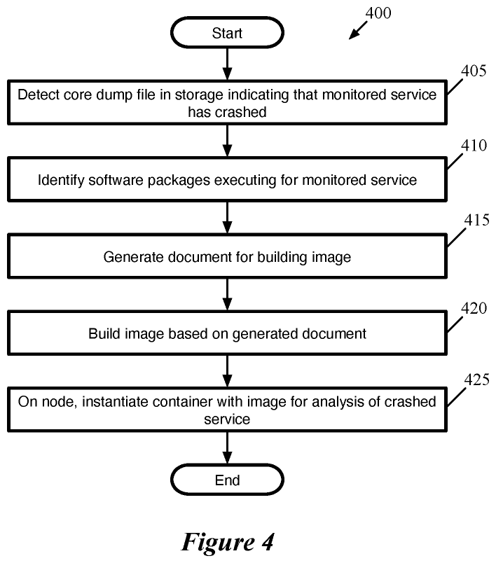

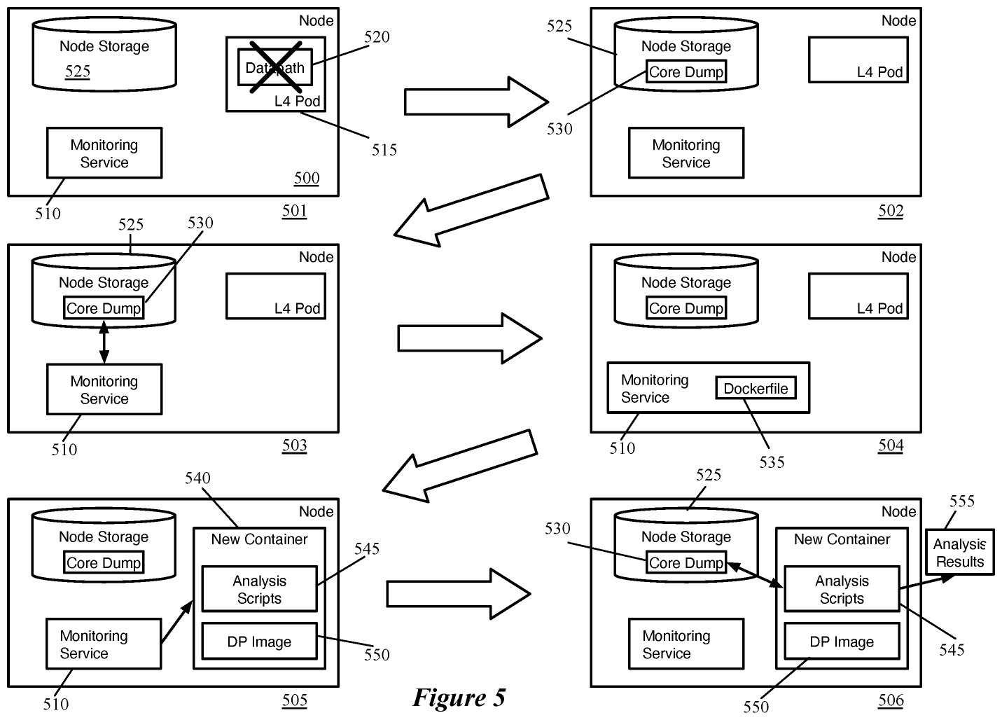

FIG. 4 conceptually illustrates a process 400 of some embodiments for performing automated debugging of a monitored service (e.g., the datapath of an L4 Pod). In some embodiments, the process 400 is performed by the monitoring service (e.g., the monitoring service 300 shown in FIG. 3). The process 400 will be discussed in part by reference to FIG. 5, which conceptually illustrates a monitoring service instantiating a new container with an image of a crashed datapath for analysis over six stages 501-506.

As shown, the process 400 begins by detecting (at 405) a core dump file in a storage indicating that a monitored service has crashed. In some embodiments, the monitoring service monitors a persistent volume storage that is shared between the L4 Pod and the monitoring service to determine when a core dump file relating to the L4 Pod (or, specifically, the datapath) is written to this storage. In some embodiments, whenever a Pod and/or service on the node crashes, the node generates a core dump file and stores the core dump file to this storage. Certain indicators in the file name and/or content of the file can be used to identify the specific service and/or Pod for which the core dump file is generated. The monitoring service is configured to watch the shared storage for these indicators in order to determine when a core dump file is stored for the datapath and/or L4 Pod.

The first stage 501 of FIG. 5 conceptually illustrates a node 500 on which a monitoring service 510 and an L4 Pod 515 operate, with a datapath 520 executing within the L4 Pod. In addition, the node 500 includes a node storage 525. The monitoring service 510 is configured to monitor the storage 525 to identify when the datapath 520 executing on the L4 Pod 515 has crashed.

In this first stage 501, the datapath 520 crashes. As a result, as shown in the second stage 502, a core dump file 530 has been written to the node storage 525. In some embodiments, processes running on the node (e.g., in the node kernel) automatically generate the core dump for any program, such as the datapath 520, when that program crashes. In some embodiments, core dump files from programs executing on any of the pods that operate on the node 500 are stored to the same storage 525.

Returning to FIG. 4, the process 400 then identifies (at 510) software packages that were executing for the monitored service. In some embodiments, the monitoring service identifies the software packages at least in part based on (i) the naming string of the core dump file and (ii) version information stored at the node. These software packages, in some embodiments, include the various datapath and control threads running for the datapath as well as DPDK libraries in some embodiments.

Based on this information, the process 400 generates (at 515) a document for building an image of the crashed service. In some embodiments, the generated document is a DockerFile, which specifies a set of commands to assemble an image (i.e., a Docker container). The document, in some embodiments, specifies the various executables to run, libraries needed, etc. In some embodiments, the information needed to generate the document is based at least in part on the core dump file. In addition, some of the information is pre-configured with the monitoring service as well.

The third stage 503 of FIG. 5 shows that the monitoring service 510 detects the core dump file 530 after the file is written to the node storage 525. In some embodiments, the monitoring service 510 is configured to examine any new files written to the node storage 525 to determine whether those files are core dumps pertaining to the specific service (i.e., the datapath 520) that the monitoring service 510 monitors. While additional files may be written to the node storage 525 (e.g., core dumps for unrelated services executing on other pods, other node files that are shared between pods, etc.), only upon detecting the core dump file 530 does the monitoring service take action. The fourth stage 504 shows that the monitoring service has generated a DockerFile 535 based on the detection of the core dump file 530. This DockerFile 535, as described above, includes commands needed to build an image of the crashed datapath.

Returning again to FIG. 4, the process 400 then builds (at 420) an image based on the generated document. The process 400 also instantiates (at 425) a container (or a new Pod) on the node to house the image and to perform analysis of the crashed service, the ends. In different embodiments, the monitoring service automatically instantiates a Pod (e.g., via the Kubernetes API server) or a simple container (e.g., a Docker container) outside of any of the Pods on that node. In some embodiments, a container is used because doing so does not require any interaction with the Kubernetes control plane and is thus simpler. This new container includes the newly built image of the datapath (and/or the entire L4 Pod) as well as a set of analysis scripts.

The fifth stage 505 of FIG. 5 illustrates that the monitoring service 510 has instantiated a new container 540, in which a set of analysis scripts 545 and a datapath image 550 (built based on the DockerFile 535) execute. In some embodiments, the monitoring service 510 instantiates a new Pod in which the new container 540 is housed, while in other embodiments the new container 540 executes outside of any Pods (but still on the node 500). The set of analysis scripts 545, in some embodiments, are predefined (i.e., are defined within the configuration of the monitoring service 510 such that any new container generated based on detection of a core dump file will include the analysis scripts 545).

The new container 540, in some embodiments, downloads the software packages identified by the monitoring service 510 into its user space, so that the analysis scripts 545 can analyze the datapath 550 as well as the core dump file 530. As shown in the sixth stage 506, the analysis scripts 545 access the core dump file 530 (as the new container 540 also has access to the shared node storage 525) to perform analysis on this file and the image of the datapath 550. The analysis scripts 545 perform debugging analysis (e.g., GNU debugger (gdb) analysis). The scripts generate a set of analysis results 555 that can be packed into support bundles for offline analysis (e.g., root cause analysis) of the crash. In some embodiments, the new container 540 exits (e.g., is deleted) after the automated scripts have completed and the results are generated. In other embodiments, however, the new container 540 remains up and is accessible by a user (e.g., an administrator, an application developer, etc.). This enables the user to perform real-time debugging of the datapath on the node 500 rather than needing to perform the analysis outside of the Kubernetes environment.

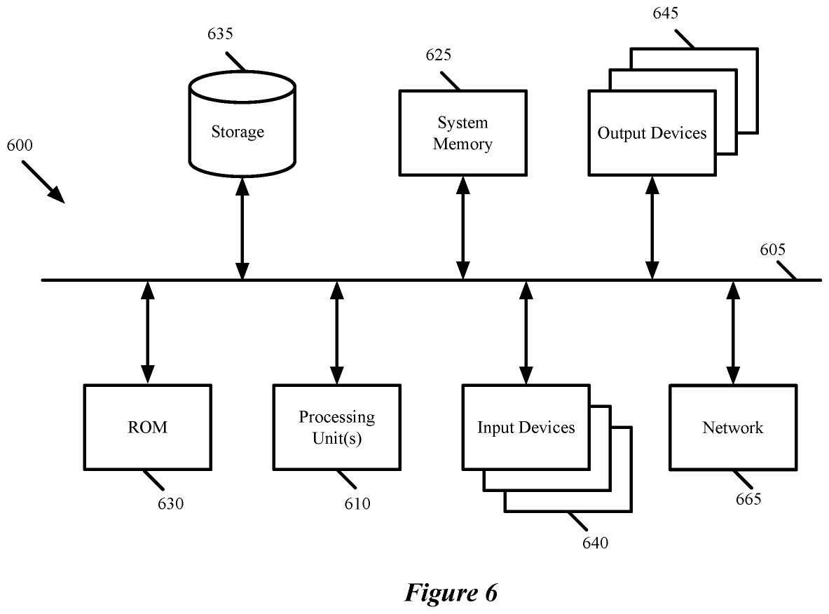

FIG. 6 conceptually illustrates an electronic system 600 with which some embodiments of the invention are implemented. The electronic system 600 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the electronic system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments.

The read-only-memory (ROM) 630 stores static data and instructions that are needed by the processing unit(s) 610 and other modules of the electronic system. The permanent storage device 635, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 635.

Other embodiments use a removable storage device (such as a floppy disk, flash drive, etc.) as the permanent storage device. Like the permanent storage device 635, the system memory 625 is a read-and-write memory device. However, unlike storage device 635, the system memory is a volatile read-and-write memory, such a random-access memory. The system memory stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices enable the user to communicate information and select commands to the electronic system. The input devices 640 include alphanumeric keyboards and pointing devices (also called “cursor control devices”). The output devices 645 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 6, bus 605 also couples electronic system 600 to a network 665 through a network adapter (not shown). In this manner, the computer can be a part of a network of computers (such as a local area network (“LAN”), a wide area network (“WAN”), or an Intranet, or a network of networks, such as the Internet. Any or all components of electronic system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 4) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method for monitoring a first service that executes in a Pod on a node of a Kubernetes deployment, the method comprising:
at a second service executing on the node:
monitoring a storage of the node that stores core dump files to detect when a core dump file pertaining to the first service is written to the storage;
upon detection of the core dump file being written to the storage, automatically (i) generating an image of the first service based on data in the core dump file and (ii) instantiating a new container on the node to analyze the generated image in order to debug the first service.

2. The method of claim 1, wherein the first service is a datapath that performs logical forwarding operations for a plurality of logical routers of a logical network.

3. The method of claim 2, wherein a plurality of additional Pods execute on a plurality of nodes of the Kubernetes deployment, including the node on which the Pod executes, to perform layer 7 (L7) services for the plurality of logical routers.

4. The method of claim 3, wherein each of the additional Pods performs one or more L7 services for a single logical router.

5. The method of claim 1, wherein the core dump file is generated when the first service crashes.

6. The method of claim 1, wherein the storage is a persistent volume storage of the node that is shared between the Pod, the second service, and the new container.

7. The method of claim 1, wherein the second service generates the image of the first service based on at least one of (i) a naming string of the core dump file and (ii) version information stored at the node.

8. The method of claim 1, wherein generating the image of the first service comprises:
identifying all software packages executing for the first service;
generating a document comprising a set of commands for building an image based on the identified software packages; and
building the image using the generated document.

9. The method of claim 8, wherein the new container downloads the identified software packages into a user space of the new container.

10. The method of claim 1, wherein the new container is instantiated with a set of automated scripts that analyze the core dump file and bundles the analysis for root cause analysis.

11. The method of claim 9, wherein the new container exits after the set of automated scripts are complete.

12. The method of claim 9, wherein the new container is accessible by a user to enable real-time debugging on the node.

13. A non-transitory machine-readable medium storing a first service which when executed on a node of a Kubernetes deployment monitors a second service that executes in a Pod on the node, the first service comprising sets of instructions for:
monitoring a storage of the node that stores core dump files to detect when a core dump file pertaining to the second service is written to the storage;
upon detection of the core dump file being written to the storage, automatically (i) generating an image of the second service based on data in the core dump file and (ii) instantiating a new container on the node to analyze the generated image in order to debug the second service.

14. The non-transitory machine-readable medium of claim 13, wherein the second service is a datapath that performs logical forwarding operations for a plurality of logical routers of a logical network.

15. The non-transitory machine-readable medium of claim 14, wherein a plurality of additional Pods execute on a plurality of nodes of the Kubernetes deployment, including the node on which the Pod executes, to perform layer 7 (L7) services for the plurality of logical routers, each of the additional Pods performing one or more L7 services for a single logical router.

16. The non-transitory machine-readable medium of claim 13, wherein the core dump file is generated when the second service crashes.

17. The non-transitory machine-readable medium of claim 13, wherein the storage is a persistent volume storage of the node that is shared between the Pod, the first service, and the new container.

18. The non-transitory machine-readable medium of claim 13, wherein the first service generates the image of the second service based on at least one of (i) a naming string of the core dump file and (ii) version information stored at the node.

19. The non-transitory machine-readable medium of claim 13, wherein the set of instructions for generating the image of the second service comprises sets of instructions for:
identifying all software packages executing for the second service;
generating a document comprising a set of commands for building an image based on the identified software packages; and
building the image using the generated document.

20. The non-transitory machine-readable medium of claim 13, wherein the new container is instantiated with a set of automated scripts that analyze the core dump file and bundle the analysis for root cause analysis.

21. The non-transitory machine-readable medium of claim 20, wherein the new container exits after the set of automated scripts are complete.

22. The non-transitory machine-readable medium of claim 20, wherein the new container is accessible by a user to enable real-time debugging on the node.
